(19) United States
(12) Patent Application Publication
(10) Pub. No.: US 2017/0070768 A1
(43) Pub. Date: Mar. 9, 2017

(54) VIDEO STREAM DECODER

(71) Applicant: FREESCALE SEMICONDUCTOR, INC., Austin, TX (US)

(72) Inventors: DEBOLEENA MINZ SAKALLEY, GHAZIABAD (IN); SNEHLATA GUTGUTIA, JAMTARA (IN); AMAN ARORA, ROHINI (IN); DIRK WENDEL, GRASBRUNN (DE); RITESH AGRAWAL, GHAZIABAD (IN); JEETENDRA GUPTA, HINDAUN CITY (IN)

(21) Appl. No.: 14/846,820

(22) Filed: Sep. 6, 2015

(51) Int. Cl. H04N 21/426; H04N 21/6543; H04N 21/462

(52) U.S. Cl. CPC H04N 21/42607; H04N 21/4622; H04N 21/6543

(57) ABSTRACT

A video stream decoder for decoding a multiple parallel-input video streams from multiple video cameras permits continuance of the decoding process even if one of the streams has stalled or if a start code of a currently active stream has become corrupted. A counter triggers a stream switching module to switch to a different input video stream on a round-robin or priority basis after a preset time period elapsed if no start code of a currently active stream has been detected.

### BACKGROUND

The present invention relates generally to video stream decoding and, more particularly, to a video stream decoder that avoids stalling during decoding.

A typical video stream, comprising encoded images output from a video camera for example, includes a start code followed by a frame followed by a start code, followed by a further frame, etc. A stream is buffered and then passed to a decoder that enables images captured by the camera to be viewed on a visual display unit. In certain systems, decoding is done serially by multiplexing different channels into one decoder input. In such arrangements, in order to decode multiple streams with a single decoder, some form of input stream switching or “context” switching is required. Typically, context may be switched from one stream to another upon detection of a code of a frame or a ‘start code’ for a slice (scans) within a frame. However if a stream stalls or if a start code of one of the streams is corrupted, the context can never switch and the decoding system keeps waiting for the start code, which in fact never appears.

Hence, it would be advantageous to have a video stream decoding system that permits recovery from situations such as stalled or corrupted streams and which permits decoding of the remaining operational streams.

### BRIEF DESCRIPTION OF THE DRAWINGS

The invention, together with objects and advantages thereof, may best be understood by reference to the following description of preferred embodiments together with the accompanying drawings in which:

FIG. 1 is a simplified, schematic block diagram of a video stream decoder in accordance with one embodiment of the invention; and

FIG. 2 is a simplified flow chart of a method of operating the video stream decoder of FIG. 1.

### DETAILED DESCRIPTION OF PREFERRED EMBODIMENTS

The detailed description set forth below in connection with the appended drawings is intended as a description of presently preferred embodiments of the invention, and is not intended to represent the only forms in which the present invention may be practised. It is to be understood that the same or equivalent functions may be accomplished by different embodiments that are intended to be encompassed within the spirit and scope of the invention. In the drawings, like numerals are used to indicate like elements throughout. Furthermore, the terms “comprises,” “comprising,” or variation thereof, are intended to cover a non-exclusive inclusion, such that module, circuit, device components, structures and method steps that comprise a list of elements or steps does not include only those elements but may include other elements or steps not expressly listed or inherent to such module, circuit, device components or steps. An element or step proceeded by “comprises . . . a” does not, without more constraints, preclude the existence of additional identical elements or steps that comprises the element or step.

In one embodiment, the present invention provides a video stream decoding system that includes a first module that selects a first video stream from a plurality of video streams for decoding and, on receipt of a switching signal, selects a second video stream from the plurality of video streams for decoding. A second module is operably coupled to the first module and generates the switching signal in response to receipt of a trigger signal. A counter is operably coupled to the second module and generates a trigger signal after a preset time period has elapsed. A third module is operably coupled to the second module and receives a selected video stream, detects a start code of the selected video stream, resets the counter, and generates a trigger signal when a start code of the selected video stream is detected.

In another embodiment, the present invention provides a method for decoding a plurality of video streams. The method includes selecting a first video stream from a plurality of video streams for decoding and, on receipt of a switching signal, selecting a second video stream from the plurality of video streams for decoding; generating the switching signal in response to receipt of a trigger signal; detecting at least one start code in a selected video stream; and generating a trigger signal either when a start code of the selected video stream is detected or after a preset time period has elapsed and no start code has been detected during the preset time period.

Advantageously, the video decoding system allows a decoding operation to continue even when one or more input video streams have stalled due to a malfunction. A stalled stream may be identified and subsequently debugged. Furthermore, the decoding operation can also continue even when a start code for any of the input video streams is corrupted. This has the advantage of preventing buffer overruns of other input streams. The video decoding system can also restart the decoding of a stalled stream after the stalled stream has recovered.

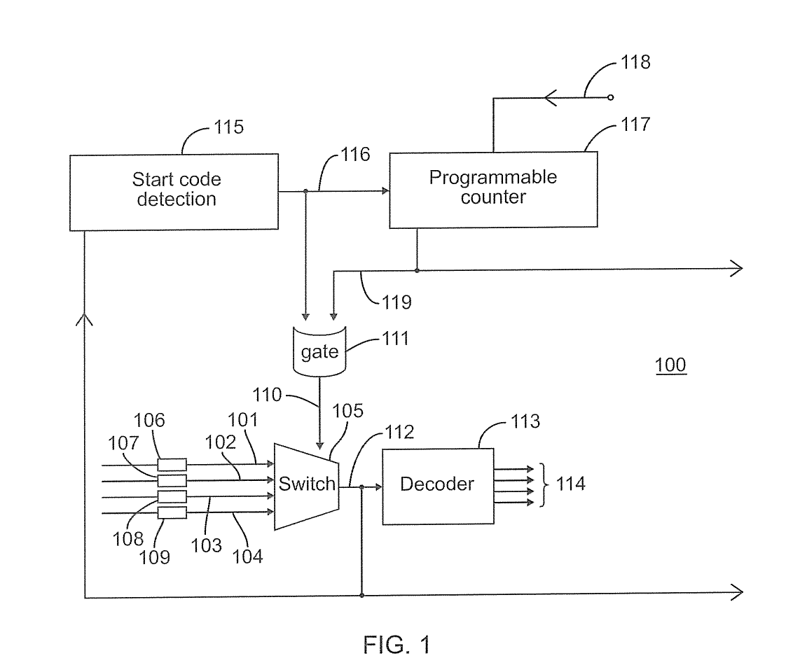

Referring now to FIG. 1, a video stream decoding system 100 in accordance with an embodiment of the invention is shown. The system 100 decodes multiple input video streams, four of which 101-104 are shown in FIG. 1. The video streams 101-104 are received by a stream switching module 105 via respective first-in-first-out (FIFO) buffers 106-109. Each of the input video streams 101-104 may comprise encoded camera images. Typically, a video stream comprises a sequence of frames, each frame including a start code at the beginning of each frame. The stream switching module 105 is configured to select one of the four input video streams 101-104 and to switch between input streams upon receipt of a switching signal on line 110, which is generated by a logic gate 111. In one embodiment, the switching between one input stream and another is done in a round robin fashion, and in another, on a priority basis.

A selected input video stream appears at an output 112 of the stream switching module 105 and is passed on to a decoder 113. Data for non-selected video streams is stored in the FIFO buffers 106-109. The decoder 113, which in this example is an H.264 decoder, outputs four decoded video streams at an output 114. The output 112 of the stream switching module 105 can be used by external circuitry (not shown) as an indication of which input video stream is currently active and being decoded. In one embodiment, the switching between video streams is also performed by changing an address from where the decoder 113 reads its incoming data. The output 112 of the stream switching module 105 is also connected to an input of a start code detection module 115. It will be understood that whereas, in this embodiment, the decoder 113 has four outputs, in other examples the decoder 113 may have just one or two outputs. The decoder's output(s) may be used to display pictures captured by a camera or may be used in further signal processing operations.

An output line 116 of the start code detection module 115 is provided to a first input of a programmable counter 117. The programmable counter 117 has a time-out value that is set by way of a second input to the programmable counter 117 on line 118. The programmed time-out value depends on the refresh rate of the frames within the video streams, the FIFO buffer sizes and a maximum allowable delay in the decoding process. A different value may be selected for each video stream individually. The output of the start code detection module 115 on output line 116 is used to reset the programmable counter 117 and also serves as a first input to the logic gate 111. An output of the programmable counter 117 on output line 119 serves as a notification signal to external circuitry (not shown) that a time-out value has expired and also serves as a second input to the logic gate 111. The logic gate 111 in this embodiment is an OR gate and generates a switching signal on its output line 110 upon receipt of an input trigger signal received either from the start code detection module 115 or the programmable counter 117. As will be explained below, the former input trigger signal occurs during error-free operation and the latter input trigger signal is generated if an error condition occurs.

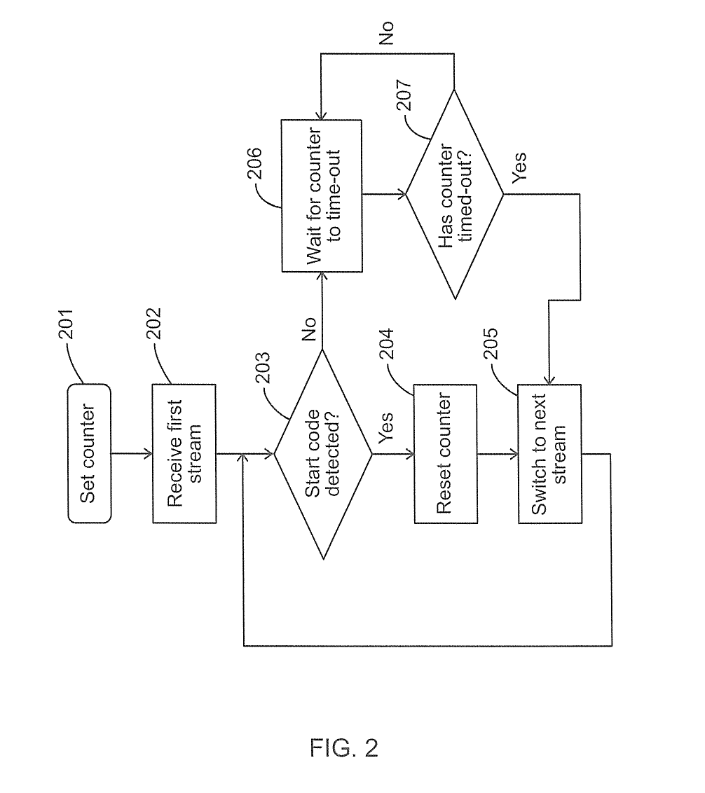

Operation of the video stream decoding system of FIG. 1 will now be described with reference to the simplified flow chart of FIG. 2.

At 201, a time-out value for the programmable counter 117 is set.

At 202, the stream switching module 105 selects and receives a first input video stream for decoding. This first input video stream is switched to the output 112 of the stream switching module 105 and so received by the decoder 113 and the start code detection module 115. The decoder 113 proceeds to decode the signal on its input while the start code detection module 115 waits for a second start code of the first input video stream to appear at its input.

At 203, when the second start code is detected by the start code detection module 115 then the start code detection module 115 generates a trigger signal on its output line 116 so that the programmable counter 117 is reset (at 204) and the gate module 111, in turn, generates a switching signal which is received by the stream switching module 105.

At 205, in response to receipt of the switching signal, the stream switching module 105 switches to the next available stream and selects a second input video stream (in either a round-robin fashion or alternatively on a priority basis, for example) from the multiplicity of input video streams 101-104. This second input video stream thus appears at the output 112 of the stream switching module 105 for decoding by the decoder 113. The process then reverts to 203 where the start code detection module 115 waits for the second start code of the second input video stream to appear on its input.

While the start code detection module 115 is waiting for the second start code of a currently active input video stream to appear at its input, the process waits for the counter to time-out (at 206), that is, the programmable counter 117 continues to count down (206) towards its time-out value. If, at 207, the programmable counter 117 times out before the second start code has been detected, then the programmable counter 117 generates a trigger signal on its output line 119, which, in turn, causes the gate module 111 to generate a switching signal which is received by the stream switching module 105.

Thus, the process moves to 205 where the stream switching module 105 selects another video input stream. Hence in a situation where the currently active video input stream stalls and so no second start code is received, then the stream switching module 105 is prompted to select another input video stream for decoding. Thus the decoding system 100 can recover from a stalled situation and continue to process valid input video streams. As mentioned above, the output of the programmable counter 117 on output line 119 can also be used as a notification signal for notifying external circuitry that an error has occurred. Such a notification signal could, for example, be accessed by an external central processing unit in order to determine which of the input video streams has failed. It can also be used as an interrupt signal which can be fed to a receiver (not shown) of the decoded images.

Advantageously, the video stream decoding system of FIG. 1 can also generate an error notification signal in a case where two consecutive start codes are detected in a space of time which is shorter than would be expected under normal operating conditions. Say for example, that a video picture is transmitted every ‘x’ milliseconds with ‘x’ being known to the start code detection module 115. If the separation of first and second start codes is less than ‘x’ then the start code detection module 115 generates an error notification signal (in addition to resetting the programmable counter 117 and generating a trigger signal for the logic gate 111). Thus, in instances where a start code is corrupted and not properly received by the start code detection module 115, the video stream decoding system is able to recover and notify external circuitry of an error condition.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Further, the entire functionality of the modules shown in FIG. 1 may be implemented in an integrated circuit. Such an integrated circuit may be a package containing one or more dies. Alternatively, the examples may be implemented as any number of separate integrated circuits or separate devices interconnected with each other in a suitable manner. An integrated circuit device may comprise one or more dies in a single package with electronic components provided on the dies that form the modules and which are connectable to other components outside the package through suitable connections such as pins of the package and bond wires between the pins and the dies.

Also for example, the examples, or portions thereof, may be implemented as software or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as computer systems.

The description of the preferred embodiments of the present invention has been presented for purposes of illustration and description, but is not intended to be exhaustive or to limit the invention to the forms disclosed. It will be appreciated by those skilled in the art that changes could be made to the embodiments described above without departing from the broad inventive concept thereof. It is understood, therefore, that this invention is not limited to the particular embodiment disclosed, but covers modifications within the spirit and scope of the present invention as defined by the appended claims.

1. A video stream decoding system, comprising:
a plurality of first-in-first-out (FIFO) buffers that receive and store a plurality of video streams;
a first module that selects a first video stream from the plurality of video streams for decoding and, on receipt of a switching signal, selects a second video stream from the plurality of video streams stored in the FIFO buffers for decoding;
a second module, operably coupled to the first module, that generates the switching signal in response to receipt of a trigger signal;
a counter, operably coupled to the second module, that generates a first trigger signal after a preset time period has elapsed, thereby causing the second module to generate the switching signal;
a third module, operably coupled to the second module, that receives the selected video stream, detects a start code of the selected video stream, resets the counter, and generates a second trigger signal when the start code of the selected video stream is detected; and
a decoder operably coupled to the first module for receiving and decoding the selected video stream.

2. The video stream decoding system of claim 1, wherein the second module has an OR functionality and generates the switching signal on receipt of one of the first and second trigger signals received from one of the counter and the third module.

3. The video stream decoding system of claim 1, wherein the first module selects the second video stream from the plurality of video streams on a round robin basis.

4. The video stream decoding system of claim 1, wherein the first module selects the second video stream from the plurality of video streams on a priority basis.

5. (canceled)

6. (canceled)

7. A method for decoding a plurality of video streams, the method comprising:
selecting a first video stream from a plurality of video streams for decoding;
on receipt of a switching signal, selecting a second video stream from the plurality of video streams for decoding;
generating the switching signal in response to receipt of a trigger signal;
detecting at least one start code in a selected video stream; and
generating the trigger signal either when a start code of the selected video stream is detected or after a preset time period has elapsed and no start code has been detected during the preset period of time.

8. The method of claim 7, further comprising resetting a counter for measuring the preset time period when the start code of the selected video stream is detected.

9. The method of claim 7, further comprising selecting the second video stream from the plurality of video streams on a round robin basis.

10. The method of claim 7, further comprising selecting the second video stream from the plurality of video streams on a priority basis.

11. The method of claim 7, further comprising generating an error notification signal when a time between two detected, consecutive start codes is determined to be less than an expected value.

12. An integrated circuit comprising the video stream decoding system of claim 1.
